(19) United States
(12) Patent Application Publication
(10) Pub. No.: US 2018/0337847 A1
(43) Pub. Date: Nov. 22, 2018

(54) INDEXING A MULTI-LAYER BLOCKCHAIN SYSTEM

(71) Applicant: PEKING UNIVERSITY SHENZHEN GRADUATE SCHOOL, Guangdong (CN)

(72) Inventors: Hui Li, Guangdong (CN); Haopeng Li, Guangdong (CN); Huajun Ma, Guangdong (CN); Han Wang, Guangdong (CN); Peng Yi, Guangdong (CN); Kedan Li, Guangdong (CN); Xin Yang, Guangdong (CN)

(73) Assignee: PEKING UNIVERSITY SHENZHEN GRADUATE SCHOOL, Guangdong (CN)

(21) Appl. No.: 15/997,726

(22) Filed: Jun. 5, 2018

Related U.S. Application Data
(63) Continuation of application No. PCT/CN2017/084432, filed on May 16, 2017.

(51) Int. Cl. H04L 12/755; H04L 12/721; H04L 29/08; H04L 12/741; G06F 17/30

(52) U.S. Cl. CPC H04L 45/021; H04L 45/70; H04L 67/1059; H04L 67/1034; G06F 17/30185; G06F 17/30206; H04L 45/54

(57) ABSTRACT

A method comprising: In some implementations, a method for indexing a multi-layer blockchain system, comprising: A. using, a top layer blockchain, to index a lower layer blockchain by recording a seed node in a transaction log of a block; B. requesting a distributed monitoring cluster to periodically check availabilities of IP addresses and ports that listed in the seed node stored in the top layer blockchain; C. maintaining, for each node in the lower layer blockchain, a separate instance of a global routing table. Each global routing table store entire topological structure of the multi-layer blockchain system, and final consistency of the global routing tables is maintained through a GOSSIP-based data communication protocol. Any node located on the lower layer blockchain described in Step C is configured to access data and services through any one of accessible nodes identified by IP addresses and ports recorded in the global routing table.

### CROSS REFERENCE TO RELATED APPLICATION

This application is a continuation of PCT patent application no. PCT/CN2017/084432, filed May 16, 2017, entitled “indexing a multi-layer blockchain system and maintaining the chain topological structure,” which is hereby incorporated by reference in its entirety.

### TECHNICAL FIELD

The present disclosure relates generally to internet technology and more particularly to indexing a multi-layer blockchain system.

### BACKGROUND

On or about Nov. 1, 2008, Satoshi Nakamoto published, on a secretive cryptography discussion forum, a research report describing his new envision of digital currency—at that moment, Bitcoin was born. In addition to the economic attributes of the Bitcoin, the blockchain technology on which Bitcoin relies has strong prospects in future applications. Bitcoin-derived blockchain is an intelligent Peer-to-Peer (P2P) network that uses distributed databases to process, transmit, and store data. A blockchain includes a series of data blocks generated using cryptographic methods. Each data block stores data concerning a number of Bitcoin network transactions, which may be used to verify the validity of the transactions (anti-counterfeiting) and to generate the next data block. Within a blockchain network, there is no core node. The functions and rights of all nodes may be identical; all nodes use a consensus algorithm to compete for the privilege of performing record-keeping (e.g., ledgering) within the blockchain network.

In this type of network, all nodes follow established rules, and all records must be verified by a majority of the network nodes. This process ensures that the distributed system can still reach a consensus when solving a Byzantine Generals' Problem.

A computer system with high cohesion and low coupling by connecting several layers of a blockchain is thus desired. The main technical challenges include how to connect multiple blockchains, and how to maintain the topological structure of the blockchains so that the services provided are efficient, usable, and robust.

The Bitcoin-derived pegged sidechains is similar to pegging Pound (currency) to gold. Unlike other cryptocurrencies which exclude the existing systems, sidechain technology may be integrated into the existing cryptocurrency systems. Sidechain technology enables the transfer of Bitcoin and other digital assets across multiple blockchains, which means that users can access new cryptocurrency systems using existing assets. Multiple sidechains can be linked to Bitcoin, each with different characteristics and purposes. All of these sidechains rely on the flexibility and scarcity guaranteed by the Bitcoin's main chain. On this basis, the sidechain technology further expands the application and innovation of blockchain technology, enabling traditional blockchains to support multiple types of assets, as well as micropayments, smart contracts, security processing mechanisms, and real-world assets registration. It can also enhance the privacy protection of the blockchain.

### SUMMARY

The present disclosure provides systems and methods for indexing a multi-layer blockchain system to address the technical problems described in the present disclosure.

In some implementations, a method for indexing a multi-layer blockchain system, comprising: A. using, a top layer blockchain, to index a lower layer blockchain by recording a seed node in a transaction log of a block; B. requesting a distributed monitoring cluster to periodically check availabilities of IP addresses and ports that listed in the seed node stored in the top layer blockchain; C. maintaining, for each node in the lower layer blockchain, a separate instance of a global routing table.

Each global routing table store entire topological structure of the multi-layer blockchain system, and final consistency of the global routing tables is maintained through a GOSSIP-based data communication protocol.

In some implementations, the step B further comprises: B1. when the seed node fails, notifying a manager node located on the lower layer blockchain, and performing maintenance or modification on the seed node.

In some implementations, any node located on the lower layer blockchain described in Step C is configured to access data and services through any one of accessible nodes identified by IP addresses and ports recorded in the global routing table.

In some implementations the top layer blockchain uses Coinbase field of a transaction record to identify a corresponding seed node.

In some implementations, any node located on the top layer blockchain is capable of acquiring load information of a node, through a cached seed node list.

In some implementations, a service provider to the lower layer blockchain ensures the validity of the seed node and updates the seed node list through the lower layer blockchain's public ledgering process.

In some implementations, a client device located on in the top layer blockchain access data and services through an index of the lower layer blockchain.

In some implementations, the client device is capable of accessing data and services from any node in the lower layer blockchain.

In some implementations, the top layer blockchain detects load condition of the seed node by periodically querying a monitoring cluster which monitors load conditions of the seed node.

### BRIEF DESCRIPTION OF THE DRAWINGS

FIG. 1 is a flowchart illustrating an example method for indexing a multi-layer blockchain system, according to some implementations.

FIG. 2 is a block diagram illustrating an example architecture of a computer system, according to some implementations.

FIG. 3 is a block diagram illustrating an example data structured implemented by Coinbase, according to some implementations.

FIG. 4 is a block diagram illustrating a table with example data categories for seed data, according to some implementations.

FIG. 5 is a block diagram illustrating an example system for maintaining the topological structure of a lower layer blockchain, according to some implementations.

FIG. 6 is a flowchart illustrating an example method for providing a response to a client request, according to some implementations.

FIG. 7 is a block diagram illustrating an example computer system for indexing a multi-layer blockchain system, according to some implementations.

### DETAILED DESCRIPTION

Existing pegged sidechain technology may have the following drawbacks.

First, excessive coupling. A pegged sidechain overly-relies on the Bitcoin main chain; for example, a pegged sidechain may rely on the main chain to provide all security and consistency guarantees. However, because sidechains were not part of the Bitcoin's original design, process for connecting different chains and access data stored across different chains are often complex and highly coupled.

Second, limited application. Following Bitcoin's cryptocurrencies design, existing sidechain technology overly focuses on capital/asset exchange and account management, while lacking other service offering. Existing blockchain applications do not take advantage of the blockchain system's modularization and functional customization features.

Third, lack of consistency. Each sidechain has different definition and execution logic for lower layer blockchains, there is no standard interface or standard maintenance protocols.

The systems and methods for indexing a multi-layer blockchain system while maintaining the chain topological structure may reduce or eliminate the above-identified technical problems.

The technologies described in the present disclosure may provide the following technical advantages. First, in a multi-layer blockchain system, a client device can quickly index the lower layer blockchains through the records in the blockchains; since the seed nodes maintain the topological structure of a complete blockchain, a client device may identify a responsive node within the entire blockchain through the seed node. Through a distributed monitoring cluster, the availability of the seed nodes can be maintained; at the same time, the seed nodes can be load-balanced through the monitoring cluster. Distributed ledger technology may be used to avoid system failure due to a single point of failure. By maintaining a node routing table, the global topological structure of the blockchain can be maintained and the load-balance for each node can be achieved.

The technologies described in the present disclosure excel at processing data stored on multiple layers of a blockchain. Compared with the original's Bitcoint-based single-layer blockchain, having multiple layers connected to each other may reduce coupling. These technologies can be applied to connect different types of blockchains, each of which may have its own problem space and application logics. The connecting of several different layers may help solve different aspects of a same technical problem, improving system efficiency, responsiveness, and robustness.

The present disclosure provides a method for indexing a multi-layer blockchain system and maintaining the chain topological structure, the method provides a unified approach for cross-chain indexing based on a multi-layer blockchain system and maintaining the chain topological structure. The method, at the same time, greatly improves the efficiency and scalability of indexing. By using the distributed nature of the blockchain to achieve load balancing, it is easy to organize a multi-layer blockchain system with low coupling while reducing the maintenance cost of the system.

A method for indexing a multi-layer blockchain system and maintaining the chain topological structure satisfies the following three characteristics: (1) organizing the entire blockchain system through the hierarchical structure, using a top layer blockchain to index a lower layer blockchain allows layering and customizing different functions. The lower layer blockchain can implement different processing logic to achieve different functions; this design reduces the degree of system coupling and allows more diverse service customization; (2) since the stability of the seed node used in the top layer blockchain to index the lower layer blockchain is not guaranteed (failure or exit), an indexing mechanism must be designed to ensure that the system is robust enough that the seed node recorded in the top layer blockchain can correctly index the lower layer blockchain; (3) a client does not know the distribution organization of the blockchains or the load condition of the nodes, the client needs to locate the corresponding data-providing server through the index of the multi-layer blockchains, the entire indexing process need to be completely transparent to the users.

Building a blockchain service network using multi-layer blockchains, the network is made of and maintained by multiple blockchains, the top layer blockchain indexes the lower layer blockchain through information recorded in the top layer blockchain. However, because the number of nodes in the lower layer block chain is uncertain or sometimes unknown, the topological structure of the lower layer blockchain is comprised of multiple nodes and constantly changes. Therefore, it is not desirable to use the node in the top layer blockchain to store the topological structure of the lower layer blockchain. We maintain the index between the top layer blockchain and the lower layer blockchain by recording a seed node list, and at the same time, using a third-party distributed monitoring cluster to ensure the availability and load balance of the seed node. The lower layer blockchain maintains its topological structure through a globally visible routing table, and load balances client service requests indexed by the top layer blockchain.

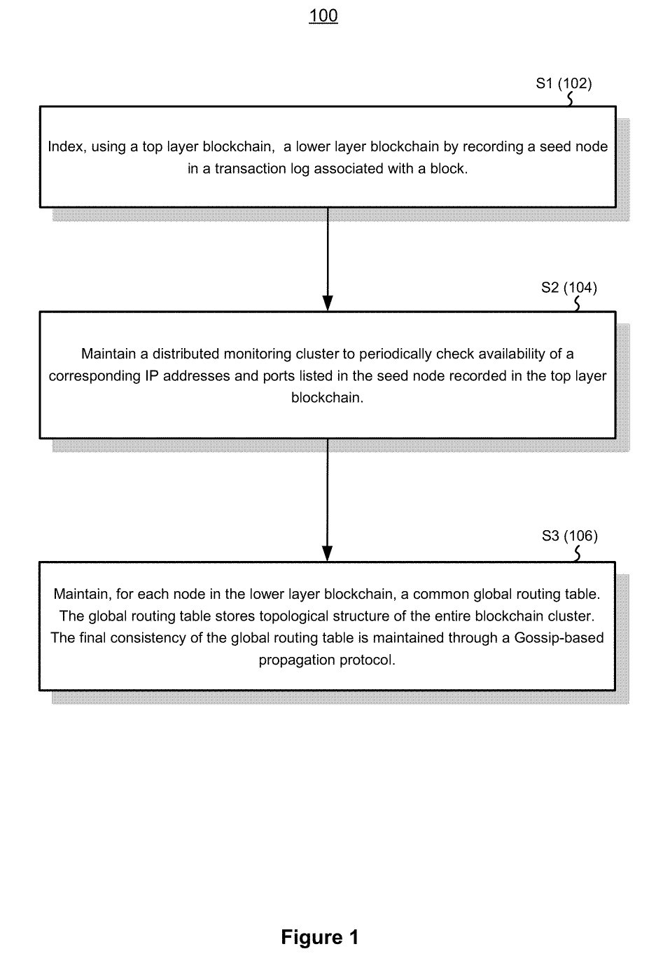

FIG. 1 is a flowchart illustrating an example method 100 for indexing a multi-layer blockchain system, according to some implementations.

At step S1 (102), a top layer blockchain indexes a lower layer blockchain by recording a seed node in the transaction log of a block.

The top layer blockchain uses the Coinbase field in a transaction to record the corresponding seed node, there must be at least one available seed node in this field record so that a client can index to the lower layer blockchain to acquire corresponding data and services. In the lower layer blockchain, interruption and failure of nodes are normal. Therefore, the service provider of the lower layer blockchain needs to ensure the validity of the seed node and updates the seed node list through the blockchain billing process. A client acquires the position of the corresponding seed node by obtaining the Coinbase field from the top layer blockchain and resolving the corresponding data type. A node in the top layer blockchain can acquire the load information of the seed node from a monitoring node by caching a seed node list, sorting the corresponding seed nodes from the lowest load to the highest load, the client is always first connected with the lower load node in the lower layer blockchain.

At step S2 (104), maintaining a distributed monitoring cluster to periodically check the availability of the corresponding IP addresses and ports that are listed in the seed node recorded in the top layer blockchain; when the seed node fails, notifying the manager of the lower layer blockchain, and maintain or modify the seed node (by modifying the record in the top layer blockchain).

The distributed monitoring cluster is comprised of an odd number of servers. It monitors the availability of the corresponding seed nodes through the paxos-like protocol. Because the distributed monitoring cluster uses the paxos-like consensus protocol, the distributed monitoring cluster will fail if and only if more than half of the cluster nodes fail. The seed nodes will actively initiate heartbeat detection to the monitoring cluster and report its running status and blockchain operation status on a regular basis. The monitoring cluster also compares the seed node list in the top layer blockchain index with the seed nodes that are connected. When a seed node fails, the monitoring cluster will notify the manager of the lower layer blockchain to fix the seed node. At the same time, the monitoring cluster also records the load condition of each seed node. The top layer blockchain can acquire the load condition of the seed node by periodically querying the monitoring cluster.

At step S3 (106), each node in the lower layer blockchain needs to maintain a common global routing table to store the topological structure of the entire blockchain cluster, the final consistency of the global routing table is maintained through Gossip-based propagation protocol.

Each node in the lower layer blockchain maintains a common global routing table to record the topological structure of the entire blockchain cluster, which means any node in the lower layer blockchain can serve as the seed node mentioned in 2.2.1.

The routing table needs to record the IP address, port number, ID of the node, and corresponding load condition of the rest of the nodes in the lower layer blockchain. Through such global or local routing table, the topological structure of the entire blockchain can be indexed from any node in the lower layer blockchain. Because the blockchain itself is a distributed global ledger, the client can acquire the service or data needed by connecting to any node in the lower layer blockchain. In addition, the routing table needs to mark the unique global blockchain ID of the lower layer blockchain, the creation time of the routing table, and the last modification time of the routing table. The nodes of the lower layer blockchain need to write the contents of the routing table to the nodes' local persistent storage periodically. If the node recovers from the failure, it will first restore the blockchain routing table from its local persistent storage, and compare the local time of the node with the last modified time on the routing table. If the last modification time is similar to the local time, the routing table is deemed legit, the rest of the nodes are connected through the records in the routing table, and the latest status of the routing table is restored through the Gossip protocol. If the table has expired for too long, the node may try to index the seed node recorded in the top layer blockchain, and obtain the routing table on the seed node through the Gossip protocol. Each node needs to maintain its own routing table, and any changes of a node are propagated through the Gossip-based protocol. Every second, each node randomly selects a peer node, and the two nodes effectively coordinate their corresponding routing tables to maintain the consistency of the routing tables of each other. If the lower layer blockchain is a private blockchain, this routing table is required to record the global node information. If the blockchain is a public blockchain and the number of nodes is too large, the peer-to-peer routing protocol—Chord can be used. Under the Chord protocol, every node maintains a rounding table at the size of O (log N), the node that needs to be accessed can be reached within O (log N) query time.

When the client wants to get the data in the lower layer blockchain, the client can first connect to the nodes in the top layer blockchain to obtain the seed node list in the top layer blockchain that records the lower layer blockchain. The client will try to access the first available seed node one by one in the order of the returned seed node list. The nodes in the lower layer blockchain have two processing logics after receiving a client's access request: (1) if the load of the node in the current blockchain does not exceed the pre-designed threshold, the data on the corresponding blockchain is queried and the client's request is responded to; (2) if the load of the node in the current blockchain exceeds the pre-designed threshold, the node's local routing table is queried and a list of accessible blockchain nodes is returned to the client, based on the nodes' IP addresses and their load conditions. When the client receives the returned list of accessible blockchain nodes from the current node, the client will first record the overload of the current node; at the same time, the client will replace the list of blockchain nodes in the local cache with the list of accessible blockchain nodes returned from the current node; the client will then resend the access request to the nodes in the order of the returned node list, and attach a list to the access request data packet. The attached list recodes the invalid node visited by the client, the overloaded node and the corresponding access time. The nodes receive the access request will update their own routing tables according to the information provided by the client, and propagate the latest routing information to other blockchain nodes in the entire network through the Gossip protocol.

The method for indexing a multi-layer blockchain system and maintaining the chain topological structure solved the main problems in a multi-layer blockchain system: (1) in a multi-layer blockchain system, a client device can quickly index the lower layer blockchains through the records in the blockchains; (2) since the seed node maintains the topological structure of a complete blockchain, a client device can identify a responsive node of the complete blockchain through the seed node; (3) through the distributed monitoring cluster, the availability of the seed nodes can be maintained, at the same time, the seed nodes can be load balanced through the monitoring cluster; (4) meanwhile, distributed ledger technology is used to avoid system failure due to a single point of failure; (5) through the maintenance of the nodes' routing table, the global topological structure of the blockchain can be maintained and the load balance of each node can be achieved.

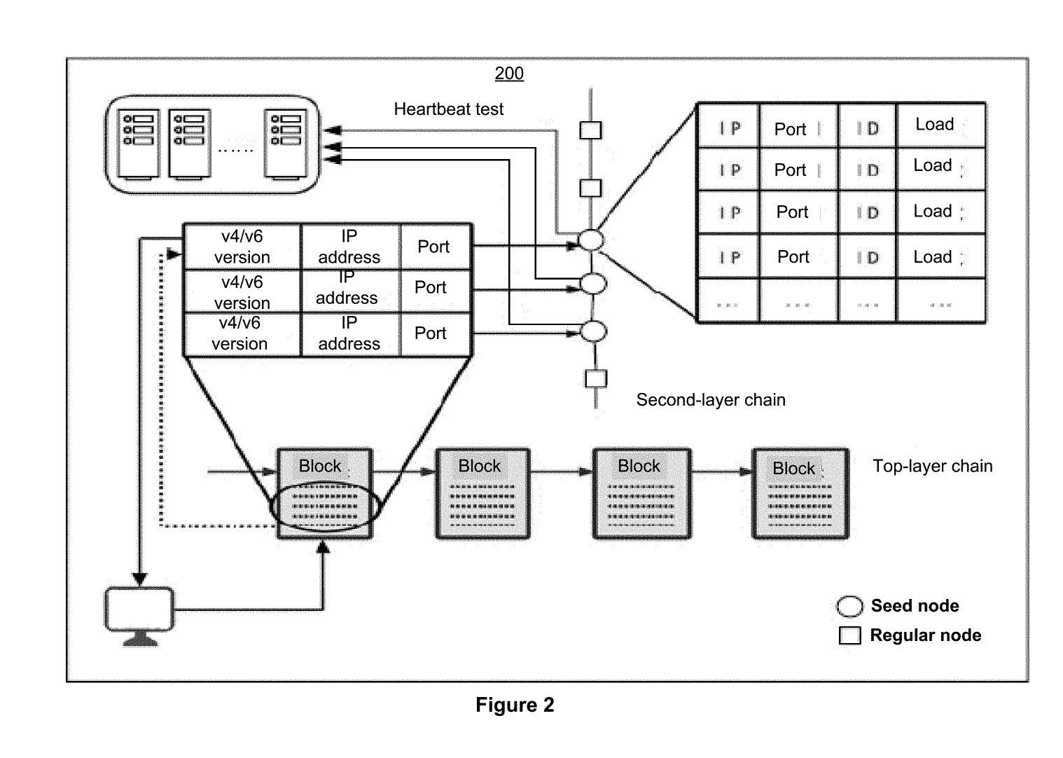

FIG. 2 is a block diagram illustrating an example architecture of a computer system, according to some implementations.

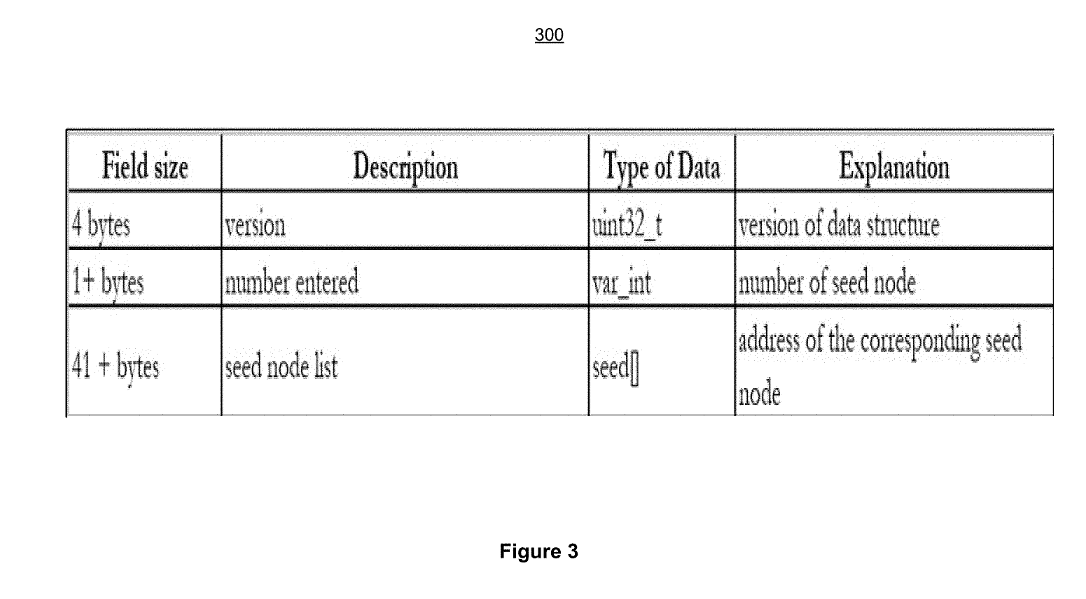

FIG. 3 is a block diagram illustrating an example data structured implemented by Coinbase, according to some implementations.

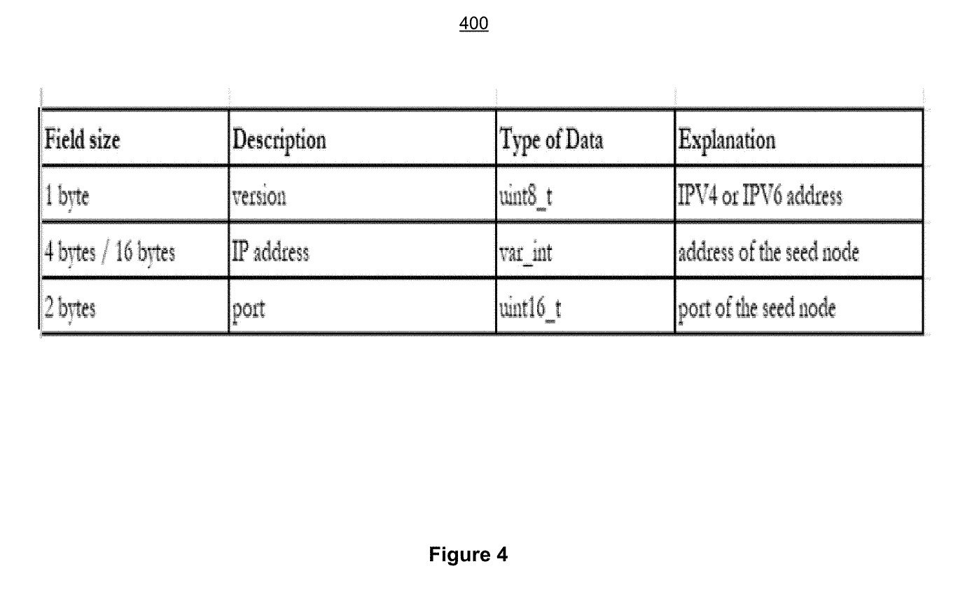

FIG. 4 is a block diagram illustrating a table with example data categories for seed data, according to some implementations.

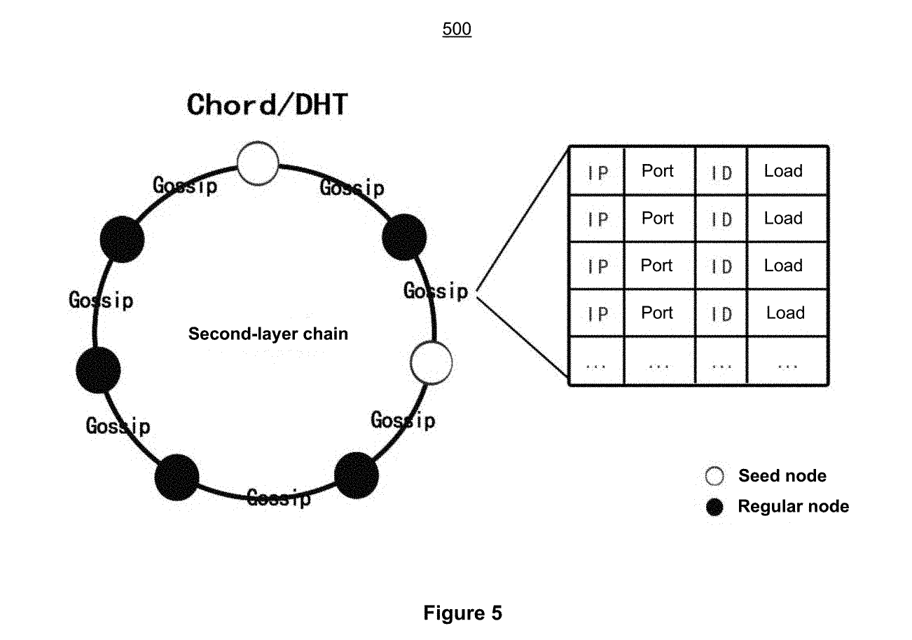

FIG. 5 is a block diagram illustrating an example system for maintaining the topological structure of a lower layer blockchain, according to some implementations.

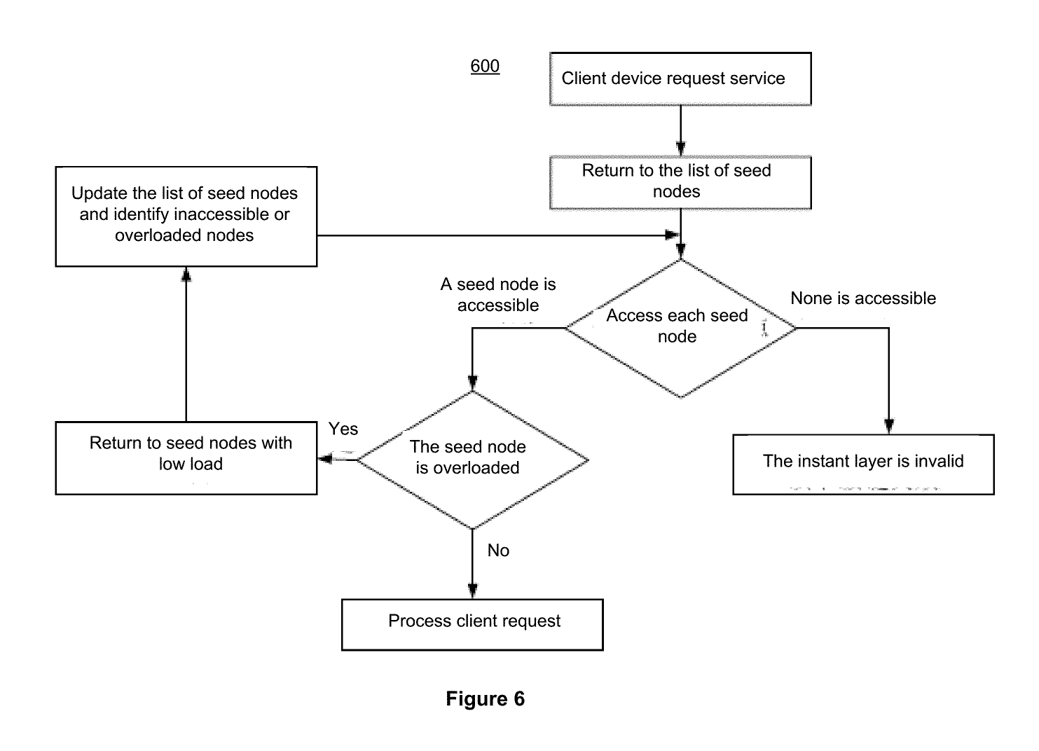

FIG. 6 is a flowchart illustrating an example method for providing a response to a client request, according to some implementations.

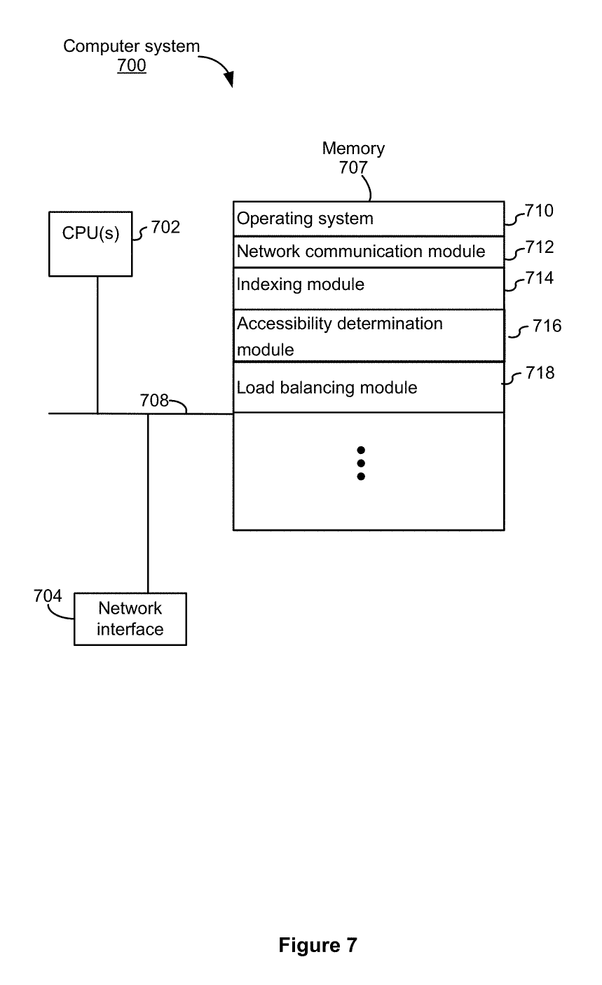

FIG. 7 is a block diagram illustrating an example computer system 700. The computer system 700 typically includes one or more processing units CPU(s) 702 (also referred to as processors), one or more network interfaces 704, memory 706, and one or more communication buses 708 for interconnecting these components. The communication buses 708 optionally include circuitry (sometimes called a chipset) that interconnects and controls communications between system components. The memory 706 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 706 optionally includes one or more storage devices remotely located from CPU(s) 702. The memory 706, or alternatively the non-volatile memory device(s) within the memory 706, comprises a non-transitory computer readable storage medium. In some implementations, the memory 706 or alternatively the non-transitory computer readable storage medium stores the following programs, modules and data structures, or a subset thereof:
an operating system 710, which includes procedures for handling various basic system services and for performing hardware dependent tasks;
a network communication module (or instructions) 712 for connecting one node with other nodes via the one or more network interfaces 704 (wired or wireless) or a communication network;
an indexing module 714 for index nodes on one or more different layers of a blockchain;
an accessibility determination module 716 for determining whether a node is currently accessible or not; and
a load balancing module 718 for balancing computing loads among several nodes;

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 606 optionally stores a subset of the modules and data structures identified above. Furthermore, the memory 606 may store additional modules and data structures not described above.

Although FIG. 7 shows a “computing system 700,” FIG. 5 is intended more as functional description of the various features which may be present in computer systems than as a structural schematic of the implementations described herein. In practice, and as recognized by those of ordinary skill in the art, items shown separately could be combined and some items could be separated.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, without changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

1. A method for indexing a multi-layer blockchain system comprising:
A. using, a top layer blockchain, to index a lower layer blockchain by recording a seed node in a transaction log of a block;
B. requesting a distributed monitoring cluster to periodically check availabilities of IP addresses and ports that listed in the seed node stored in the top layer blockchain;
C. maintaining, for each node in the lower layer blockchain, a separate instance of a global routing table, wherein
each global routing table store entire topological structure of the multi-layer blockchain system, and
final consistency of the global routing tables is maintained through a GOSSIP-based data communication protocol.

2. The method of claim 1, wherein step B further comprises:
B1. when the seed node fails, notifying a manager node located on the lower layer blockchain, and performing maintenance or modification on the seed node.

3. The method of claim 2, wherein any node located on the lower layer blockchain described in Step C is configured to access data and services through any one of accessible nodes identified by IP addresses and ports recorded in the global routing table.

4. The method of claim 3, wherein the top layer blockchain uses Coinbase field of a transaction record to identify a corresponding seed node.

5. The method of claim 4, wherein any node located on the top layer blockchain is capable of acquiring load information of a node, through a cached seed node list.

6. The method of claim 5, wherein a service provider to the lower layer blockchain ensures the validity of the seed node and updates the seed node list through the lower layer blockchain's public ledgering process.

7. The method of claim 6, wherein a client device located on in the top layer blockchain access data and services through an index of the lower layer blockchain.

8. The method of claim 7, wherein the client device is capable of accessing data and services from any node in the lower layer blockchain.

9. The method of claim 8, wherein the top layer blockchain detects load condition of the seed node by periodically querying a monitoring cluster which monitors load conditions of the seed node.
